(19) United States
(12) Patent Application Publication
(10) Pub. No.: US 2024/0067290 A1
(43) Pub. Date: Feb. 29, 2024

(54) Holder System for Bicycle Fork

(71) Applicant: Canyon Bicycles GmbH, Koblenz (DE)

(72) Inventors: Kai Schackers, Ochtendung (DE); Matthias Eurich, Koblenz (DE); Matthias Hensolt, Koblenz (DE)

(21) Appl. No.: 18/229,246

(22) Filed: Aug. 2, 2023

(30) Foreign Application Priority Data
Aug. 31, 2022 (DE) 20 2022 104 927.0

(51) Int. Cl. B62J 7/06

(52) U.S. Cl. CPC B62J 7/06

(57) ABSTRACT

A holder system for a bicycle fork for fastening pieces of luggage on a bicycle fork includes a holder means 14. The holder means 14 for pieces of luggage can be connected to a fork leg 10. Beside an in particular clamping connection by means of clamping elements 26, a connecting element 20, 22 for a positive connection of the holder means 14 to the fork leg 10 is provided.

### CROSS REFERENCE TO RELATED APPLICATION

This application claims priority to German Patent Application No. 20 2022 104 927.0 filed on Aug. 30, 2022, the disclosure of which is hereby incorporated by reference in its entirety.

### BACKGROUND OF THE INVENTION

### Field of the Invention

The invention relates to a holder system for a bicycle fork for fastening pieces of luggage, such as luggage bags, drink bottles and the like, on a bicycle fork.

### Description of Related Art

For fastening pieces of luggage on a bicycle fork, in particular on a fork leg of the bicycle fork, it is known to provide threaded sleeves in the fork leg which is also referred to as a fork beam. Here, typically, three threaded sleeves are arranged one above the other in the longitudinal direction of the fork leg. Holders for pieces of luggage, such as luggage bags, or holders for receiving drink bottles or the like may be provided in the threaded sleeves using screws. Providing threaded sleeves in the fork legs is a complex step in the manufacturing of bicycle forks which are often made of carbon fiber, since the corresponding threaded sleeves have to be positioned precisely during the manufacturing of the bicycle forks. In addition, the weight of the bicycle fork is increased thereby. This is undesirable in particular with racing bikes, gravel bikes and the like, since corresponding holders for pieces of luggage are not used all the time, but only during corresponding bicycle tours. Often, such pieces of luggage are not mounted at all by the user, so that the provision of the corresponding threaded sleeves offers no advantage to many users. Further, the stiffness of the fork is increased by the provision of threaded sleeves in the bicycle forks. This is undesirable in particular with gravel bikes in which the bicycle fork must have a certain flexibility to dampen the unevenness of a track. Moreover, such threaded sleeves are optically disadvantageous in particular if no pieces of luggage are mounted.

It is an object of the invention to provide a holder system for a bicycle fork for fastening pieces of luggage, which does not necessarily require the provision of threaded sleeves.

### SUMMARY OF THE INVENTION

According to the invention, the object is achieved by a holder system for a bicycle fork as described herein.

The holder system for a bicycle fork according to the invention serves for fastening pieces of luggage, such as luggage bags, drink bottles or the like. The bicycle fork is a conventional bicycle fork with a fork bridge connected to a steer tube. Typically, two fork legs or fork beams are connected to the fork bridge, while bicycle forks with only one fork leg are also known. A holder means for pieces of luggage can be connected to the at least one fork leg. For this purpose, a connecting element is provided by which a positive connection of the holder means to the fork leg is possible. By such a positive connection, the position of the holder means on the fork leg is defined. Even when riding on an uneven ground, it is thus ensured that the holder means, and thus pieces of luggage connected to the holder means, will not shift. With a bicycle fork having two fork legs, corresponding holder means may be provided on each fork leg.

The invention will be described hereinafter with reference to a holder means provided on a fork leg.

The holder means is preferably designed such that it encloses at least a part of the fork leg in a collar-like manner. Likewise, the holder means may comprise a plurality of collar-like protrusions which enclose at least a part of the fork leg at different heights or different positions with respect to the longitudinal direction of the fork leg. It is particularly preferred that the holder means has a cross section that is at least partly U-shaped. In this region, it is preferred that the holder means encloses the fork leg in a collar-like manner.

Thus, it is preferred for mounting that the holder means is bent open slightly, so as to then be slipped over the fork leg in the manner of a collar. In particular, the bent-open collar-like holder means is slipped onto a front side of the fork leg directed in the traveling direction.

For forming the connecting element which realizes a positive connection, it is particularly preferred that the connecting element has a protrusion on the holder means or the fork leg, which engages into a recess correspondingly provided in the fork leg or the holder means. In the mounted state, the protrusion thus engages into the recess so that a positive connection is made. For an improvement of the connection, it is also possible to provide a plurality of such connecting elements, wherein, for example, one connecting element is arranged in an upper region and a further connecting element is arranged in a lower region of the holder means. It is further preferred that the at least one protrusion is connected integrally with the holder means or the fork leg.

It is further preferred that the protrusion or the recess is provided on an inner side of the fork leg. Here, the inner side of the fork leg is the side of the fork leg directed towards the front wheel. With forks having two fork legs, the inner sides are the sides of the two fork legs that face each other.

For a further fixation of the holder means it is preferred that the holder means comprises at least one clamping element. The clamping element is preferably designed such that a collar-like holder means is clampingly fixed on the fork leg by the clamping element in addition to the connecting element. Thus, the holder means is preferably compressed by the clamping element, so that an inner side of the holder means is pressed against an outer side of the fork leg. Such clamping elements kay, for example, be cable straps which are cut open to release the holder means, if they are one-way cable straps. It is preferred that the at least one clamping element comprises a screw and nut connection. Appropriate screws may engage into openings arranged in the holder means. In particular, the holder means comprises tabs in which the openings are formed. Thus, in the mounted state, the screws may be arranged laterally in front or behind the fork leg with respect to the traveling direction. An arrangement on a side of the fork leg is preferred that is the rear side with respect to the traveling direction.

In a preferred development of the clamping elements, these are designed such that the clamping elements are additionally designed for fixing holders for the piece of luggage or for a direct fixation of the piece of luggage. It is preferred that the clamping elements have a double function, so that, on the one hand, the holder means is additionally clamped on the fork leg and, on the other hand, holder means for the piece of luggage are mounted. This allows different holders for different pieces of luggage to be mounted in a simple manner.

Moreover, it is preferred that the holder means comprises a composite fiber material, in particular is made of a composite fiber material, so that the holder means has a lower weight.

The invention described above with reference to a holder system for a bicycle fork may also be formed on a seat stay or another bicycle frame component.

In the following, the invention is described in more detail by means of a preferred embodiment with reference to the accompanying drawings.

### BRIEF DESCRIPTION OF THE DRAWINGS

The terms Fig., Figs., Figure, and Figures are used interchangeably in the specification to refer to the corresponding figures in the drawings.

In the Figures:

FIG. 1. shows a schematic perspective side view of two bicycle fork leg, and

FIG. 2. shows a schematic sectional view of along line II-II in FIG. 1.

### DESCRIPTION OF THE INVENTION

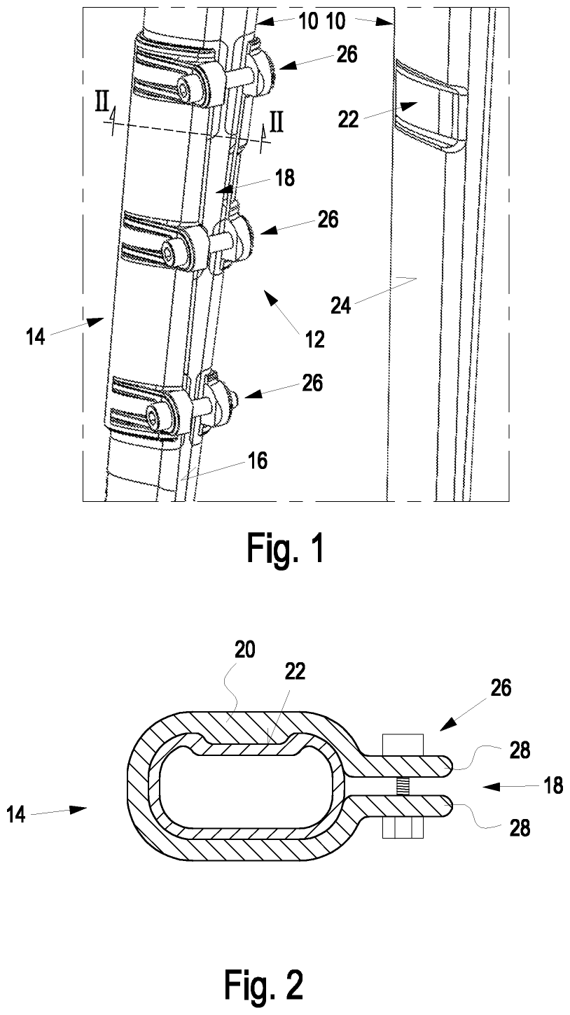

FIG. 1 schematically shows two fork legs 10 of a bicycle fork which is not illustrated in its entirety. The fork legs 10 are connected to a fork bridge in the upper region and the fork bridge is connected to a steer tube. In the lower region, i.e. in the region of the drop-out ends of the two fork legs 10, the same have receptacles for the front wheel axis.

The fork leg 10, which is the left fork leg both in FIG. 1 and with respect to the traveling direction 12, comprises a holder means 14 in the embodiment illustrated. A corresponding holder means could also be arranged on the fork leg on the right-hand side with respect to the traveling direction. The holder means 14 is designed in a collar-like manner and has a U-shaped cross section. On a side which in the mounted state is arranged at the rear 16 of the fork leg 10, the holder means has a slot 18 extending over the entire length.

The holder means 14 has a protrusion 20 (FIG. 2) in particular to prevent a shifting of the holder means 14 on the fork leg 10. The protrusion 20 extends into a recess 22 when in the mounted state. The recess 22 is arranged on an inner side 24 of the fork leg 10. If it is possible to provide a holder means 14 on both fork legs 10, the two recesses 22 are thus arranged opposite each other and face each other. In the embodiment illustrated, the protrusion 20 is connected to or integrally formed with the holder means 14.

For a further fixation of the holder means 14 on the fork leg 10, three clamping means 26 are provided in the embodiment illustrated. The three clamping means 26 are configured as screw-nut connections. For connection to the holder means 14, the same has three pairs of tabs 28 directed opposite to the traveling direction 12 and having passage openings for inserting the screw therethrough. Beside the positive connection between the holder means 14 and the fork legs 10, a clamping connection is made via the connecting element 20, 22 by tightening the crew-nut connection 26, so that a secure fixation of the holder means 14 on the fork leg 10 is ensured. Furthermore, holders for pieces of luggage, bottles or the like can be connected using one or a plurality of holder means 26. As such, the clamping elements 26, preferably designed as screws, have a double function.

1. A holder system for a bicycle fork for fastening pieces of luggage on a bicycle fork, comprising
a bicycle fork with at least one fork leg,
a holder means for pieces of luggage, which is adapted to be connected to the fork leg and
a connecting element for a positive connection of the holder means to the fork leg.

2. The holder system for a bicycle fork according to claim 1, wherein the holder means at least partly encloses the fork leg in a collar-like manner.

3. The holder system for a bicycle fork according to claim 1, wherein the holder means is at least partly U-shaped in cross section.

4. The holder system for a bicycle fork according to claim 1, wherein the connecting element comprises a protrusion connected to the holder means or the fork leg, which protrusion engages into a recess provided in the fork leg or in the holder means.

5. The holder system for a bicycle fork according to claim 4, wherein the protrusion is integrally formed with the holder means or the fork leg.

6. The holder system for a bicycle fork according to claim 4, wherein the protrusion or the recess are provided on an inner side of the fork leg.

7. The holder system for a bicycle fork according to claim 1, wherein, for fixation on the fork leg, the holder means comprises at least one clamping element.

8. The holder system for a bicycle fork according to claim 7, wherein the at least one clamping element comprises a screw-nut connection cooperating with openings in the holder element.

9. The holder system for a bicycle fork according to claim 7, wherein the at least one clamping element is arranged on a side of the fork leg which is a rear side with respect to the traveling direction.

10. The holder system for a bicycle fork according to claim 7, wherein at least one clamping element is additionally designed for fixing the piece of luggage and/or of holders for the piece of luggage.

11. The holder system for a bicycle fork according to claim 1, wherein the holder means comprises composite fiber material, in particular that it is made of composite fiber material.
